(19) United States
(12) Patent Application Publication
(10) Pub. No.: US 2005/0030248 A1
(43) Pub. Date: Feb. 10, 2005

(54) Antenna arrangement

(75) Inventors: Roland Gabriel, Griesstatt (DE); Jorg Langenberg, Prien A. Chiemsee (DE); Jurgen Rumold, Bad Endorf (DE)

Correspondence Address: NIXON & VANDERHYE, PC, 1100 N GLEBE ROAD, 8TH FLOOR, ARLINGTON, VA, 22201-4714, US

(73) Assignee: Kathrein-Werke KG,, Rosenheim (DE)

(21) Appl. No.: 10/635,005

(22) Filed: Aug. 6, 2003

(51) Int. Cl. H01Q 21/00; H01Q 9/16

(52) U.S. Cl. 343/853; 343/820

(57) ABSTRACT

An improved antenna arrangement has the following features:
the at least two antenna element systems (3.1, 3.2) are arranged and/or fed such that the main lobe (7.1) of the first antenna element device (3.1) and the main lobe (7.2) of the second antenna element device (3.2) include an angle (α) between one another,
a network (13) is provided via which the first antenna element system (3.1) and the second antenna element system (3.2) can be supplied with a signal whose intensities can be set differently relative to one another, so that it is possible in this way to set a different angular transmission direction (α) for the antenna arrangement.

The invention relates to an antenna arrangement according to the precharacterizing clause of claim 1.

The mobile radio antennas which are provided for a base station normally in particular have an antenna arrangement with a reflector in front of which a large number of antenna elements are provided, which are offset with respect to one another in the vertical direction, and thus form an array. These antenna elements may, for example, transmit and receive in one or two mutually perpendicular polarizations. The antenna elements may in this case be designed to receive in only one frequency band. However, the antenna arrangement may also be designed as a multiband antenna, for example for transmitting and receiving two frequency bands which are offset with respect to one another. What are referred to as triband antennas are also in principle known.

As is known, mobile radio networks are in the form of cells, with each cell having an associated corresponding base station with at least one mobile radio antenna for transmitting and receiving. The antennas are in this case constructed such that they generally transmit and receive with a main lobe which points downwards at a specific angle with respect to the horizontal, thus defining a specific cell size. This depression angle is also referred to, as is known, as the down-tilt angle.

A phase shift arrangement for this purpose has already been proposed in WO 01/13459 A1, in which the down-tilt angle of a single-column antenna array having two or more antenna elements which are arranged one above the other can be adjusted continuously and differently. According to this prior publication, difference phase shifters are used for this purpose, which, when set differently, result in the delay time length and hence the phase shift at the two outputs of each phase shifter being adjusted in different directions, thus allowing the down-tilt angle to be set.

In this case, the setting and adjustment of the phase shifter angle can be carried out manually or by means of a retrofitted unit which can be remotely controlled as is known, for example, from DE 101 04 564 C1.

Although, in principle, the setting of different down-tilt angles by varying the phase angle which is supplied to the individual antenna elements has been proven, the object of the present invention is to provide a solution which is different to this and is at the same time simplified for setting different transmission angles, in particular down-tilt angles, and/or to provide new capabilities for adjusting the transmission angle.

According to the invention, the object is achieved on the basis of the features specified in claim 1. Advantageous refinements of the invention are specified in the dependent claims.

According to the present invention, the phase can be adjusted continuously between two limit values without any problems. Within the scope of the invention, this can be done solely by appropriate power splitting. If, however, the signals which are supplied to the individual antenna elements are also shifted in time in addition to power splitting, then it is even possible to scan beyond the range of the system lobes.

The invention is in this case based on an antenna which has at least two antenna element systems, with each antenna element system being composed of at least one individual antenna element, but generally of two or more individual antenna elements, with the at least two antenna element systems being arranged offset with respect to one another and in this case transmitting and receiving in at least one polarization plane. If, for example, one antenna element in one antenna element system is set to a down-tilt angle of 0° and a second antenna element in the second antenna element system is set pointed downwards at a down-tilt angle of 10° with respect to the horizontal, then the antenna arrangement according to the invention allows any desired angle to be set in a continuously variable manner, that is to say any desired down-tilt angle in between. If the time shift between the signals which are supplied to the antenna elements is also taken into account, it is possible to scan beyond the range of the two system lobes.

In detail, this is achieved according to the invention, in that one input signal is split between various antenna elements, that is to say between the at least two antenna elements which are provided with an offset with respect to one another, with the individual components of the (correlated) signals being supplied to the antenna elements with different amplitudes. If the total energy is supplied, for example, only to the upper antenna element, which transmits at 0° with respect to the horizontal, then all of the transmitted energy is contained in the main lobe in the horizontal direction. If the total intensity is supplied to the lower antenna element device which, by way of example, has been preset to a down-tilt angle of 10° , then all the transmission energy is contained in the main lobe at this down-tilt angle of 10°. If the energy is now continuously diverted to an increased extent from one antenna element to the other, so that the two antenna element systems or at least the two antenna elements are supplied with different proportions, then the intensity split of the energy which is supplied to the at least two antenna elements results in the alignment of the main lobe being varied continuously and, in the explained example, it can thus be varied between 0° and a maximum of 10° with different transmission angles with respect to the horizontal plane. If, however, the signals are also shifted laterally in addition to splitting the power between the two individual signals, then,—as has already been mentioned—it is also possible to scan beyond the range of the two system lobes.

In comparison to conventional antennas, the antenna array loads the antenna elements in a considerably narrower manner, preferably by a factor of 2. The vertically arranged antenna elements are preferably associated alternately with the two antenna element systems, that is to say, by way of example, the lower most antenna element is associated by means of the feed with the first antenna element system, the antenna element located above it is associated with the second antenna element system, the third antenna element from the bottom is once again associated with the first antenna element system, etc. The two antenna element systems are also referred to as sub-arrays.

If the corresponding antenna elements or their polarization directions are aligned vertically, then this makes it possible to set different down-tilt angles. If the antenna elements are aligned such that they are offset in the horizontal direction alongside one another or their antenna element or polarization plane is aligned in the horizontal direction, then the continuous different intensity supply of the signal allows a different angle setting to be produced in the azimuth direction and not in the elevation direction. In this case as well, scanning beyond the range of the two system lobes is once again possible by taking into account an additional time shift in addition to the pure power splitting.

If, however, an antenna array having at least two columns and having at least two antenna elements in each column is used, by way of example, then superimposed adjustment can be carried out both in the vertical direction and in the horizontal direction, in order to appropriately align the main lobe in space, with this all being done just by supplying different intensities, that is to say by feeding the signal with a different intensity for the individual antenna elements. Different phase angles are also feasible.

The solution according to the invention is, of course, in principle also possible for use for antenna elements which transmit and receive using two mutually perpendicular polarizations and in the process are preferably aligned at angles of +45° and −45° with respect to the horizontal (or vertical). The principle can likewise be used not only for a single band antenna but also for a multiband antenna which has appropriate antenna elements for 2, 3 etc., frequency bands.

In this case, furthermore, it is also possible to change the limit value which is defined by the basic setting of the antenna elements, for example by mechanical adjustment and possibly also by different angular settings, mechanically by remote control. Furthermore, by additionally using different phase settings, it is possible to set an upper or lower limit value for the antenna arrangement differently such that the different intensity supply once again makes it possible to produce any desired intermediate value for the main lobe alignment between the limit values predetermined in this way.

In one particularly preferred embodiment, an appropriate antenna arrangement is fed by means of a network which splits the power between the antenna elements that are provided. This may be done, for example, in conjunction with a phase shifter which, in the simplest case, is once again in the form of a difference phase shifter which, for example, interacts with a 3 dB 90° hybrid. The signals are applied to the input of the hybrid with the same amplitude but with different phases. This results in the signals at the output of the network being in phase, but with different amplitudes. This therefore makes it possible to provide a feed with the same phase but with different amplitudes by the different phase control, by means of different settings of the phase shifter that is upstream of the network.

However, not only is it possible to arrange the individual antenna elements vertically and join them together to form antenna element systems, for example with an alternating split, but the antenna elements or antenna element systems can also be arranged alongside one another, rather than one above the other. In principle, other arrangements are also feasible which differ from an arrangement which is offset only vertically or only horizontally. In consequence, the usefulness of the invention is not just restricted to a variable or fixed change to the vertical alignment of the polar diagram, but in principle an arrangement for control of the horizontal alignment of the antenna lobe can also be provided. For example, in this way, it is possible to produce antennas and antenna systems which produce two horizontal polar diagrams, depending on the circuitry of a network. In a similar way to the splitting of the power for the vertical case, it is possible to use a suitable additional network to set the overall alignment between the directions of the two individual lobes in a continuously variable manner when the antenna elements are arranged horizontally, as well. If phase shifting is also used in addition to pure power splitting, that is to say a time shift is. produced between the signals, then scanning can be carried out beyond the two system lobes both in the horizontal direction and in the vertical direction. An appropriate combination of vertical and horizontal control in this case also makes it possible to produce a continuously variable alignment in space.

Further advantages, details and features of the invention will become evident in the following text from the exemplary embodiment which is illustrated in the drawings, in which, in detail:

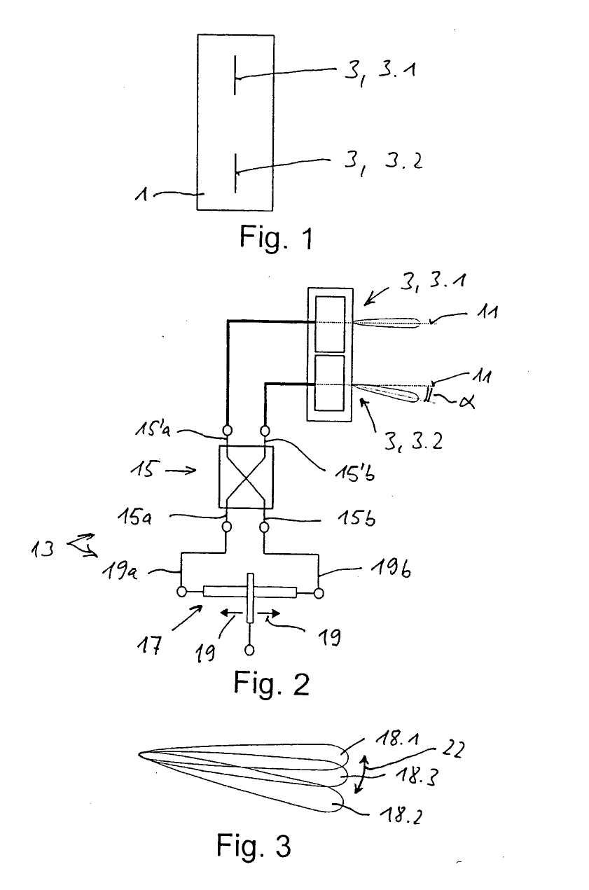

FIG. 1: shows a schematic front view of an antenna arrangement with two antenna elements (Dipole antenna elements) which are arranged one above the other;

FIG. 2 shows a schematic illustration from the side of the antenna arrangement shown in FIG. 1 with an upstream network having a 90° hybrid and a difference phase shifter for amplitude control;

FIG. 3 shows a schematic view of the differently preset lobes of the antenna arrangement and of the overall system lobe, which can be set as required between them and is produced by superimposition;

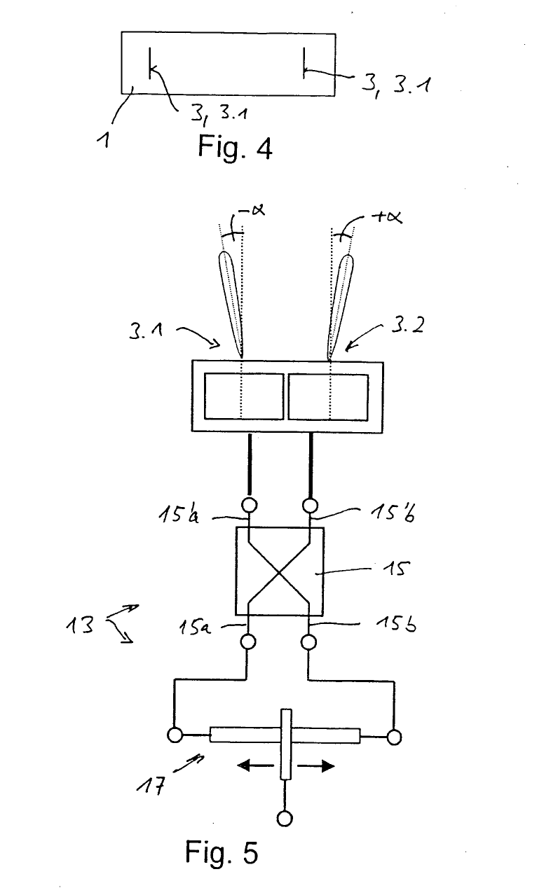

FIG. 4 shows an exemplary embodiment modified from that shown in FIG. 1;

FIG. 5 shows a corresponding example for setting a different azimuth angle for the main lobe;

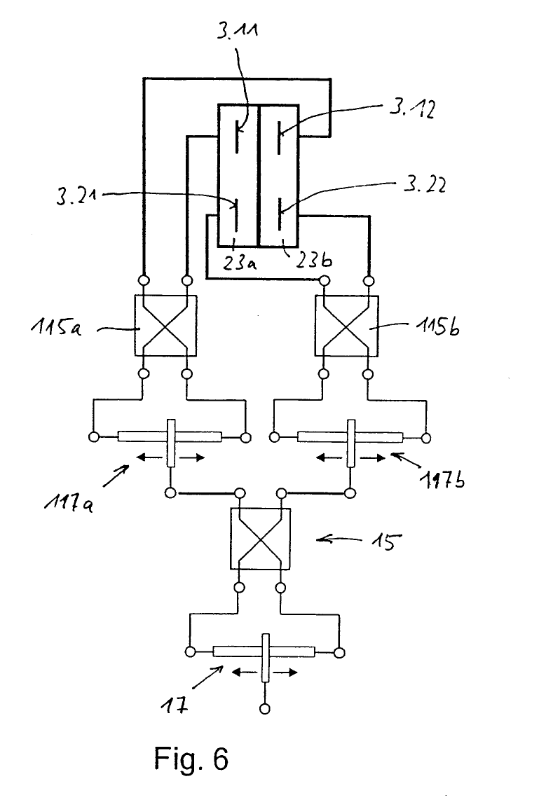

FIG. 6 shows an example of a corresponding different setting for a lobe which is produced by superimposition and which can be set differently in the azimuth and elevation directions;

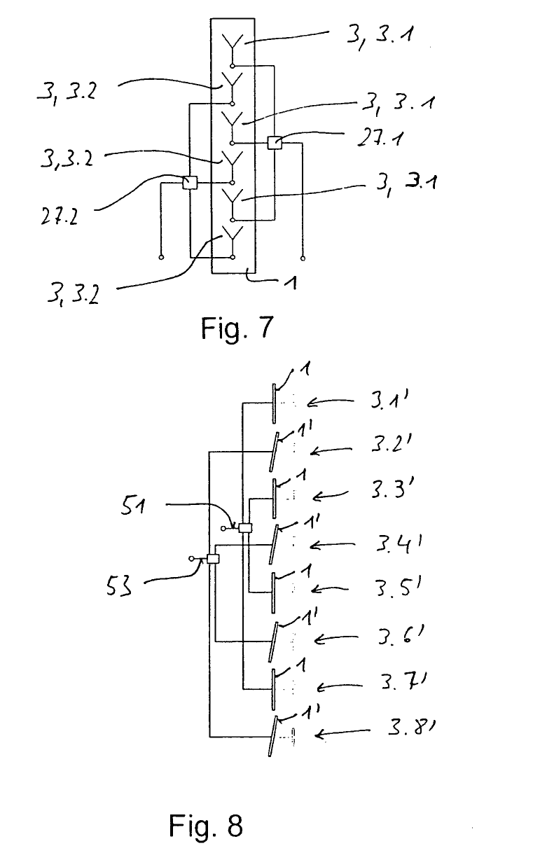

FIG. 7 shows a schematic view of a further exemplary embodiment; and

FIG. 8 shows a further schematic exemplary embodiment of an antenna system with antenna elements which are arranged alternately one above the other, with the two antenna element systems each being provided with individual antenna elements or antenna element groups which follow one another alternately, and the associated reflectors in at least one antenna element group being aligned at a different angle to the reflectors in the other antenna element group.

FIG. 1 shows a schematic front view of an antenna arrangement with a vertically aligned reflector 1, in front of which two antenna element devices 3 are arranged vertically one above the other. In the illustrated exemplary embodiment, each of the two antenna element devices 3 is formed from a dipole antenna element 3.1 or 3.2, respectively, aligned vertically. The antenna arrangement thus transmits and receives in a vertical polarization plane, in one frequency band.

FIG. 2 likewise shows, illustrated purely schematically, a side view of the antenna arrangement shown in FIG. 1, in order to illustrate the principle according to the invention. The two antenna element devices 3 are in this case in the exemplary embodiment explained, preset (for example by mechanical alignment) in the factory for example (fixed) such that the upper antenna element device 3.1 transmits and receives exactly in the horizontal direction, and the lower antenna element device 3.2 transmits and receives inclined downwards with a down-tilt angle α of 10° with respect to the horizontal plane, for example. This presetting can likewise be permanently set by appropriate mechanical prior adjustment. The main lobes 7.1 and 7.2 of the two antenna element devices 3.1 and 3.2 are shown in FIG. 2, as is the respectively associated horizontal plane 11.

In the illustrated exemplary embodiment, the antenna arrangement formed in this way is fed by a network 13 which, in the illustrated exemplary embodiment, comprises a hybrid circuit 15, for example a 3 dB 90° hybrid, which is preceded by a phase shifter 17, in the illustrated exemplary embodiment a difference phase shifter 17.

The control process in the illustrated exemplary embodiment will be explained in the following text, assuming a basic setting in which the phase shifter 17 is in its neutral mid-position, with the signals coming from the phase shifter being applied with the same amplitude to the respective inputs 15a and 15b of the hybrid circuit 15. When the phase shift 17 is in its central initial or neutral position, then the signals at the two inputs 15a and 15b of the hybrid circuit 15 also have the same phase angle.

If, however, the phase shifter is now shifted from the central neutral position to the left or right, for example as illustrated by the arrow 19, then the phase angle at the input 15a is not the same as that at the input 15b, solely because the signal coming from the phase shifter in the input branch 19a arrives earlier if the electrical line is shortened, and that in the second branch 19b it arrives later, since the path length is longer and the delay time resulting from this is greater. This means that the corresponding signals are now once again produced with the same phase angle but with different amplitudes at the output of the network, that is to say at the output 15′a and 15′b. If these signals, which are now in phase, are passed with the corresponding different amplitudes to the two antenna element systems, that is to say to the antenna element devices 3.1 and 3.2, then, depending on the position of the phase shifter, the upper antenna element device 3.1 or the lower antenna element device 3.2 receives a different, larger or smaller proportion of the intensity of the signal that is fed in.

If the entire intensity of the signal were to be fed exclusively just to the upper antenna element device 3.1, then the explained antenna arrangement would transmit and receive exactly in the horizontal direction (since the lower antenna element device 3.2 is not supplied with any energy at all). If the entire feed signal were supplied exclusively to the lower antenna element device 3.2, then the entire antenna array would transmit exactly at the down-tilt angle α of, for example, 10° in the illustrated exemplary embodiment. If, however, the signal is now supplied with different intensities to both the upper antenna element device 3.1 and the lower antenna element device 3.2, then, depending on the position of the phase shifter and hence as a function of the different split in the intensities, the polar diagram can now be depressed, with the main beam lobe hence being depressed, as required within the limiting interval from 0° to α=10°. This is illustrated schematically by the respective main lobes 18.1 and 18.2 in FIG. 3 which represent the two transmission angles, which are set in a fixed manner in the factory for the upper antenna element 3.1 and for the lower antenna element 3.2. The corresponding split in the intensity between the upper and lower antenna element system 3.1, 3.2 now makes it possible to set a main lobe 18.3 to different intermediate transmission angles, considering only the far field, by superimposition of the intensities of the main lobes 18.1 and 18.2, which can be set differently.

If, for example, a controller is used in the base station and/or a controllable accessory for example in the form of a stepping motor, then this can be used to drive the phase shifter 17 appropriately and in a very simple manner to set the antenna such that the resultant transmission lobe is depressed to the desired extent.

The exemplary embodiment as explained and as illustrated in FIGS. 1 to 3 thus allows the main lobe (which is produced by superimposition) of the antenna arrangement to be set differently in the elevation direction.

In the same way, however, it is also possible to produce a different transmission angle setting in the horizontal direction, that is to say in the azimuth direction. In this context, reference is made to the exemplary embodiment shown in FIG. 4, in which a corresponding antenna arrangement having two antenna element devices 3.1 and 3.2 is described, although these are now offset with respect to one another in the horizontal direction. The fact that the polarization plane need not in this case be arranged in the longitudinal direction of the reflector, but can also run in any other direction, for example transversely with respect to the longitudinal extent direction of the reflector, is likewise illustrated in FIG. 4, by the fact that, there, the two antenna element devices 3.1 and 3.2 which are arranged with a lateral offset in the horizontal direction can likewise once again be aligned vertically, that is to say they can transmit and receive in a vertical polarization plane.

As is shown in FIG. 5, the feed is likewise once again provided via a network 13 as explained with reference to FIG. 2. In this case as well, a signal with the same intensity but with a different phase angle can be supplied to the two inputs 15a and 15b of the hybrid circuit 15 by appropriate adjustment of the phase shifter from its central neutral position, and, at the outputs 15′a and 15′b of the hybrid circuit 15, this means that the signal which is produced there is now supplied with the same phase angle but with different intensity to the two antenna element devices 3.1 and 3.2. If, by way of example, provision is made in this exemplary embodiment (FIG. 5 is in this case intended to show a schematic illustration of the antenna arrangement with two antenna element systems 3.1 and 3.2 which are arranged alongside one another in a horizontal plane) for the two antenna element devices 3.1 and 3.2 to transmit and receive at respective angles of −α and +α, for example at −15° and +15°, with respect to a central vertical plane, the beam direction of the main lobe can now be set differently between these two extreme values at −15° and +15°, by appropriate intensity splitting.

An antenna array having two columns 23a and 23b will now be described with reference to FIG. 6, in which two antenna element devices 3.11 and 3.21 which are arranged one above the other are provided in one column or 3.12 or 3.22 in the second column.

An input signal is now supplied to the input 17a of the first phase shifter 17 which, corresponding to its adjustment direction via the downstream hybrid circuit 15, produces at the output of the hybrid circuit 15 a signal with the same phase angle but with a different intensity. This is once again used, for example, to adjust the down-tilt angle of the antenna array as shown in FIG. 6. The two corresponding signals are, however, now influenced by a corresponding circuit with a phase shifter 117a or 117b, respectively, and by a respectively downstream hybrid circuit 115a or 115b, once again via the phase shifters 117a, 117b, such that, depending on the position of the phase shifter, a greater or lesser signal intensity at the output is supplied either to the upper dipole antenna element 3.11 or 3.12, and greater or lesser intensity is likewise supplied either to the lower dipole antenna element 3.21 or 3.22. In this exemplary embodiment as shown in FIG. 6, the two phase shifters 117a and 117b in the second stage are preferably coupled to one another in this case, so that the intensity distribution for the antenna elements in the left-hand column 23a and in the right-hand column 23b is split in the same ratio to one another.

By appropriate setting or adjustment of the phase shifter 17 in the first stage of the network and in conjunction with the downstream hybrid 15 in the first stage, this arrangement allows the down-tilt angle to be adjusted, and by appropriate operation or setting of the phase shifters 117a and 117b with the respectively associated hybrid circuits 115a, 115b in the second stage, this arrangement allows corresponding angular adjustment to be carried out in the azimuth direction, in order to set the main lobe as required between the transmission angles as governed by the system, as limit values. The corner or limit values for the different adjustable down-tilt angles are in principle determined by the two system lobes. These limit values may, however, be exceeded if separate phase shifting is also carried out for one or more antenna elements, and the signal is supplied with a corresponding phase shift.

FIG. 7 shows an antenna arrangement having two or more individual antenna elements or antenna element devices 3, to be precise by way of example for two antenna element systems. A signal is in each case supplied via a sum and branching circuit 27.1 to a group of antenna elements associated with the first antenna element system 3.1, the corresponding signal is supplied via a second sum or branching circuit 27.2 to a group of antenna elements which is associated with the second antenna element system 3.2 and which are in each case arranged alternately vertically one above the other. These may, for example, be dipole antenna elements or else other antenna element devices, such as patch antenna elements. An appropriate hybrid circuit and a phase shifter arrangement comparable to that shown in FIG. 2 in this case allow angular adjustments to be made, in which case the first antenna element group can be set in the factory to have a predetermined down-tilt angle of, for example, α=0°, 2°, 4° etc., and with the second antenna element group with the second antenna element device 3.2 having, for example, a fixed down-tilt angle of 10°, 12°, 16°. A down-tilt angle between the limit value predetermined in this way can then be set just by intensity splitting. An identical arrangement can, of course, also be used once again in a manner corresponding to the exemplary embodiment shown in FIGS. 4 and 5 to align the main node differently in the azimuth direction.

The essential feature of the arrangement shown in FIG. 7 is that, in comparison to conventional antennas, this results in considerably narrower use of the antenna element, with the interval separation preferably being less by a factor of 2 than with known antenna arrangements. The major difference from the existing antenna arrangement is thus now that the distance between the individual antenna elements should preferably be in the region of half the wavelength of the operating frequency instead of in the region of one entire wavelength, as is known from conventional antenna arrangements. This reduction in the antenna interval separation “by a factor of about 2”, can be used to produce particularly useful individual polar diagrams with sidelobes which are as small as possible.

The following text also refers to a further exemplary embodiment, as shown in FIG. 8.

As is shown in FIG. 8, improved polar diagrams with reduced sidelobes are achieved if the individual antenna elements in the antenna element system with a depressed main lobe intrinsically have individual polar diagrams with a down-tilt angle in the region of the desired down-tilt of the overall antenna element system.

A down-tilt such as this can be achieved for the individual antenna element by, for example, the corresponding reflector area having the desired inclination, as is shown in the exemplary embodiment of FIG. 8. Thus, in the exemplary embodiment shown in FIG. 8, there is no common reflector plane, and reflectors are provided which are associated separately with the individual antenna elements. In this case the arrangement is once again constructed in an alternating fashion such that, for example, the first, third, fifth, seventh etc., antenna elements 3.1′, 3.3′, 3.5′ and 3.7′ are fed via a line system 51 with an appropriate power splitter 53, and such that the antenna element systems 2, 4, 6, 8 etc., (that is to say the antenna element systems 3.2′, 3.4′, 3.6′ and 3.8′) which are arranged one above the other are fed via a line system 55 with a downstream power splitter 57. The odd-numbered antenna element systems 3.1′, 3.3′, 3.5′ etc., have, by way of example, associated reflectors 1, which are aligned in the vertical direction (but which may also have a different angle to this and may be preset). The respective even-numbered antenna element systems 3.2′, 3.4′, 3.6′ etc., have reflector systems 1′ which are set at a different angle, for example at an angle which can be preset or can be varied mechanically, with respect to the first antenna element systems 3.1′, 3.3′, 3.5′ etc. The mechanical adjustment can in this case likewise once again be carried out by remote control via an adjustment module which can be remotely controlled and which can set the reflectors 1′, as shown in FIG. 8, in the second antenna element systems at a different angular direction, as required. This exemplary embodiment shows that additional adjustment of individual antenna elements can be carried out either electrically by different setting of a phase offset, or else mechanically, as explained.

Further possible ways to depress the individual polar diagrams are feasible, for example by the addition of parasitic antenna elements in the vicinity of the respective dipoles.

The arrangement is preferably in each case designed such that adjacent antenna elements are not influenced or are influenced only to an insignificant extent by inclined reflector walls or parasitic antenna elements. This can be achieved in the case of dipole antenna elements, for example, by the individual dipoles being isolated from one another by separating walls.

1. Antenna arrangement comprising:
at least two antenna element systems each having at least one antenna element,
the at least two antenna element systems are arranged with an offset with respect to one another in the horizontal and/or vertical direction, preferably in front of a reflector,
the at least two antenna element systems transmitting and receiving in at least one polarization plane,
wherein:
the at least two antenna element systems are arranged and/or fed such that the main lobe of the first antenna element device and the main lobe of the second antenna element device include an angle between one another,
a network via which the first antenna element system and the second antenna element system can be supplied with signals whose intensities can be set differently relative to one another, so that it is possible in this way to set a different angular transmission direction for the antenna arrangement.

2. Antenna arrangement according to claim 1, wherein the two antenna element systems are arranged vertically one above the other.

3. Antenna arrangement according to claim 1, wherein the at least two antenna element systems are arranged with a horizontal offset with respect to one another.

4. Antenna arrangement according to claim 1, wherein at least two columns are provided, with at least two antenna element devices being arranged one above the other in each column, by which means the alignment direction of the main lobe, which is produced by superimposition, of the antenna arrangement can be adjusted in the elevation and azimuth directions.

5. Antenna arrangement according to claim 1, wherein the network has a hybrid circuit and a phase shifter arrangement, such that the phase shifter arrangement allows a signal preferably with the same intensity but at a different phase angle to be supplied to the inputs of the hybrid circuit such that a signal at the same phase angle but with the different intensity is produced at the output of each of the hybrid circuits.

6. Antenna arrangement according to claim 1, wherein the phase shifter arrangement is formed from a difference phase shifter.

7. Antenna arrangement according to claim 1, wherein the phase shifter arrangement is formed from an arrangement with line paths of different length.

8. Antenna arrangement according to claim 1, wherein the antenna arrangement has at least two antenna element systems, with each antenna element system having at least two antenna elements, with the antenna elements in the first antenna element system in each case being arranged offset to one another with respect to the antenna elements in the second antenna element system, preferably alternately with respect to one another along a fitting direction.

9. Antenna arrangement according to claim 1, wherein the at least two antenna element systems each have at least two, and preferably more, antennas or antenna elements which are arranged interleaved in one another, preferably alternately, in the fitting direction.

10. Antenna arrangement according to claim 9, wherein the distance between the individual antennas or antenna elements which are arranged such that they are interleaved is in the region of half the wavelength of the operating frequency.

11. Antenna arrangement according to claim 1, wherein the at least two antenna element systems have two or more antennas and antenna elements which are arranged interleaved with one another and preferably alternately as antenna elements which are arranged in a plane, in two fitting directions that are at an angle to one another, preferably in two fitting directions that are at right angles to one another, and in that a network is provided, via which the main lobe can be aligned in space by means of a combination of preferably vertical and horizontal control.
